(19) United States
(12) Patent Application Publication
(10) Pub. No.: US 2016/0106620 A1
(43) Pub. Date: Apr. 21, 2016

(54) MASSAGE APPARATUS

(71) Applicant: TOYOTA BOSHOKU KABUSHIKI KAISHA, Aichi-ken (JP)

(72) Inventors: Yosuke UNO, Nagakute-shi (JP); Koji SAITO, Toyota-shi (JP); Masashi YANAGAWA, Kasugai-shi (JP); Masahiko ONUMA, Nagakute-shi (JP)

(73) Assignee: TOYOTA BOSHOKU KABUSHIKI KAISHA, Aichi-ken (JP)

(21) Appl. No.: 14/885,337

(22) Filed: Oct. 16, 2015

(30) Foreign Application Priority Data
Oct. 17, 2014 (JP) 2014-212299

(51) Int. Cl. A61H 9/00

(52) U.S. Cl. CPC A61H 9/0078; A61H 2201/1215

(57) ABSTRACT

A massage apparatus includes: a pump that is an air supply source; a motor that actuates a distributor; a power switch that optionally supplies power to the pump and the motor to actuate the pump and the motor; and a limit switch that is connected in parallel with the power switch, and is operated by a cam working with the distributor so as to be turned ON when the distributor assumes a position to supply air to any of bladders, and so as to be turned OFF when the distributor assumes a position to discharge air from at least any of the bladders.

### INCORPORATION BY REFERENCE

The disclosure of Japanese Patent Application No. 2014-212299 filed on Oct. 17, 2014 including the specification, drawings and abstract is incorporated herein by reference in its entirety.

### BACKGROUND OF THE INVENTION

1. Field of the Invention

The invention relates to a massage apparatus that performs a desired massage by supplying and discharging air to and from a bladder provided in the apparatus of a seat or the like.

2. Description of Related Art

In an air mat apparatus disclosed in Japanese Patent Application Publication No. 9-38153, a plurality of bladders are arranged in a planar manner to constitute an air mat. The bladders are divided into a plurality of groups, and air is alternately supplied to and discharged from the bladders in the respective groups, so that a body of a person lying on the air mat is massaged.

With similar uses as the above air mat apparatus, a massage seat for a vehicle is developed. The massage seat has a plurality of bladders arranged inside a vehicle seat. The bladders are divided into a plurality of groups, and air is alternately supplied to and discharged from the bladders in the respective groups, so that a body of a seated occupant is massaged. During a massage operation being actuated, air is alternately supplied to and discharged from the bladders in the respective groups disposed in the respective part of the vehicle seat via a distributer. When the massage operation is stopped, air is discharged from the bladders so that the bladders become the initial state. It is because no part of the vehicle seat is deformed due to the inflated bladders when the massage operation is stopped so that the massage seat is used as a regular vehicle seat. Accordingly, the distributor is provided with a rotational position detection sensor so that an air discharge position of the distributor is detected. When the air discharge position of the distributor is detected by the rotational position detection sensor, each of the operations of the distributor and a pump as an air supply source is stopped. That is, the distributor and the pump continue to be actuated even after the massage operation of the massage seat is stopped until the air discharge position of the distributor is detected. When the air discharge position of the distributor is detected, the actuations of the distributor and the pump are automatically stopped.

However, in the above conventional massage seat, an optical sensor is used as the rotational position detection sensor, and the air discharge position of the distributor is specified by using a counter. Thus, a circuit that actuates the counter upon receiving a signal from the optical sensor is required, so that a configuration becomes disadvantageously complicated, and a cost is disadvantageously increased.

### SUMMARY OF THE INVENTION

The invention provides a massage apparatus that performs a massage action by sequentially supplying and discharging air to and from a plurality of bladders via a distributor, and stops the massage action after continuing the action until the distributor assumes an air discharge position at the time of stopping the massage action, wherein a configuration of an electric circuit that actuates a pump and the distributor is simplified by directly stopping the pump and the distributor by a cam switch that is actuated upon receiving a motion of the distributor.

An aspect of the invention is a massage apparatus that performs a massage action by sequentially supplying and discharging air to and from a plurality of bladders via a distributor, the massage apparatus including: a pump that is an air supply source; a motor that actuates the distributor; a power switch that optionally supplies power to the pump and the motor to actuate the pump and the motor; and a limit switch that is connected in parallel with the power switch, and is operated by a cam working with the distributor so as to be turned ON when the distributor assumes a position to supply air to any of the bladders, and so as to be turned OFF when the distributor assumes a position to discharge air from at least any of the bladders.

According to the aspect of the invention, the pump and the distributor are actuated when the power switch is turned ON, so that the air supply and the air discharge with respect to the bladders are performed. When the power switch is turned OFF, the power supply to the pump and the distributor is continued via the limit switch, and the pump and the distributor are continuously actuated until the distributor assumes the air discharge position. When the distributor reaches the air discharge position, the limit switch is turned OFF by the cam working with the distributor, so that the actuation of the pump and the distributor is stopped. Therefore, the pump and the distributor are always stopped at the air discharge position of the distributor. Moreover, since the pump and the distributor are stopped by the cam working with the distributor and the limit switch, an extra circuit such as a conventional circuit that actuates a counter becomes unnecessary, and a circuit configuration can be simplified.

In the aspect of the invention, the distributor may be a rotary-type distributor, and the rotary-type distributor may include: a stator having a plurality of output ports that are air passages connected to the bladders, respectively, an air supply port that is an air passage connected to the pump, and an air discharge port that is an air passage open to an atmosphere; a rotor that rotates relative to the stator, and, at each of a plurality of air supply positions set for each predetermined rotational angle, brings the air supply port into communication with an output port of a bladder corresponding to the air supply position out of the output ports, and, at a plurality of air discharge positions set between the respective air supply positions, brings the air discharge port into communication with the output port most recently in communication with the air supply port; and the cam that is set on a rotational outer periphery of the rotor, and is formed so as to turn OFF the limit switch at a position corresponding to each of the air discharge positions, and turn ON the limit switch at a position other than the air discharge positions.

According to the above structure, the cam has such a structure as to turn OFF the limit switch at each of the air discharge positions during the rotation of the rotor. Thus, the cam can be configured only by forming such a cam shape as to turn OFF the limit switch according to each of the air discharge positions for the predetermined rotational angles of the rotor on the rotational outer periphery of the rotor, and the cam structure can be simplified.

In aspect of the invention, in the stator, the plurality of output ports may be dispersedly arranged in a circular shape, the air supply port may be disposed in the center of the circular shape, the air discharge port may be disposed between the output ports and the air supply port in a radial direction of the circular shape, the plurality of air discharge ports may be dispersedly arranged concentrically with the plurality of output ports, and the rotor may bring the output port most recently in communication with the air supply port into communication with all of the air discharge ports at each of the air discharge positions.

According to the above structure, the output port is brought into communication with the plurality of air discharge ports at each of the air discharge positions. Thus, an air discharge capacity can be increased, and an air discharge rate of each of the bladders can be raised. Also, even when the air discharge capacity is increased, an amount of air discharged from each of the air discharge ports is not increased. Thus, a discharge sound generated when air flows through the air discharge ports at high speed can be suppressed.

In the aspect of the invention, the cam may include a projection that is provided projecting to an outer peripheral side of the rotor corresponding to each of the air discharge positions set between the respective air supply positions in the rotor, the limit switch may be turned OFF when the projection of the cam comes into abutment with the limit switch, and may be turned ON when the projection of the cam is separated from the limit switch, and the projection may be formed so as to have an inclined surface at a front end portion in a rotational direction of the rotor such that a projection amount with respect to the limit switch is gradually increased along with the rotation of the rotor when the projection starts to abut with the limit switch.

According to the above structure, the projection of the cam is formed so as to have the inclined surface at the front end portion. As a result, an abutting force generated when the projection and the limit switch come into abutment with each other is not rapidly increased, but is gradually increased. Accordingly, wear of an abutting portion between the projection and the limit switch is suppressed, and durability can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view illustrating a state in which a massage apparatus according to one embodiment of the invention is mounted in an automobile seat;

FIG. 2 is a system configuration diagram illustrating electrical wiring and air piping in the above embodiment;

FIG. 3 is a front view illustrating an appearance of a rotary-type distributor in the above embodiment;

FIG. 4 is a side view illustrating the appearance of the rotary-type distributor similarly to FIG. 3;

FIG. 5 is a plan view illustrating the appearance of the rotary-type distributor similarly to FIG. 3;

FIG. 6 is a bottom view illustrating the appearance of the rotary-type distributor similarly to FIG. 3;

FIG. 7 is a plan view of a stator of the rotary-type distributor in the above embodiment;

FIG. 8 is a sectional view taken along a line VIII-VIII in FIG. 7;

FIG. 9 is an enlarged bottom view of a rotor of the rotary-type distributor in the above embodiment;

FIG. 10 is a sectional view taken along a line X-X in FIG. 9;

FIG. 11 is a sectional view illustrating a state when the rotor is at an air supply position for explaining a function of the rotary-type distributor in the above embodiment; and

FIG. 12 is a sectional view illustrating a state when the rotor is at an air discharge position similarly to FIG. 11.

### DETAILED DESCRIPTION OF EMBODIMENTS

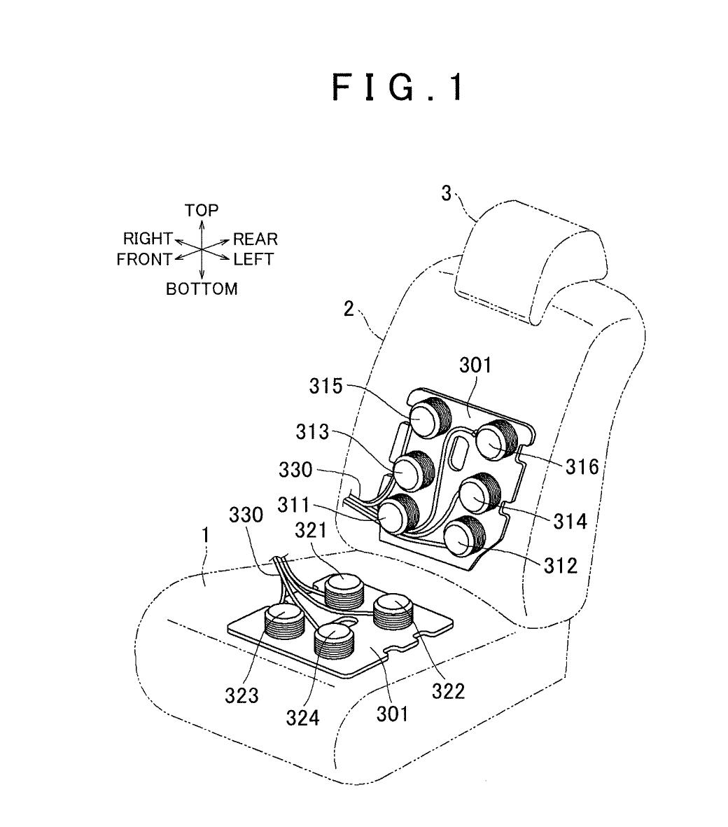

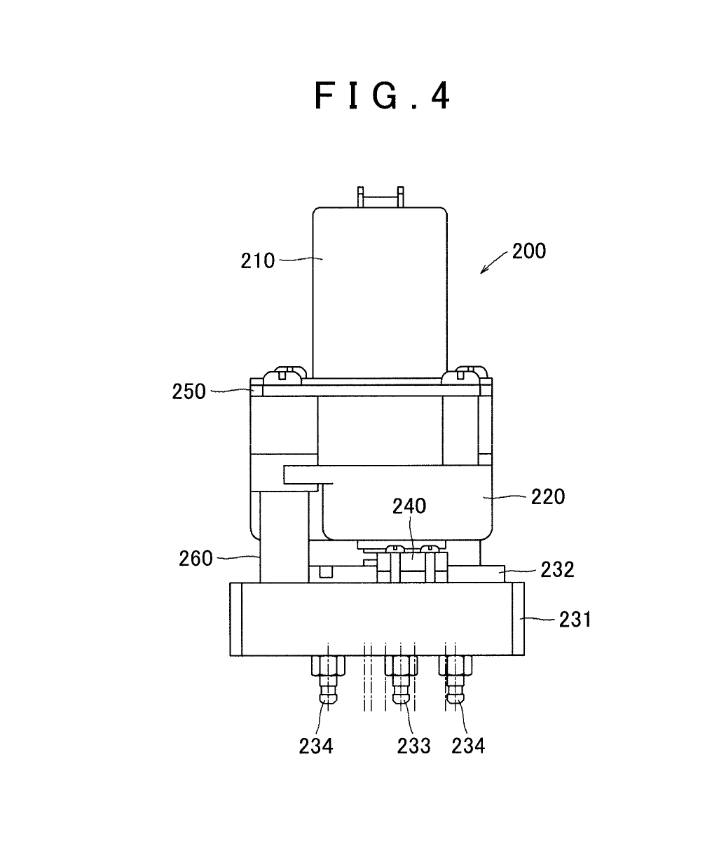

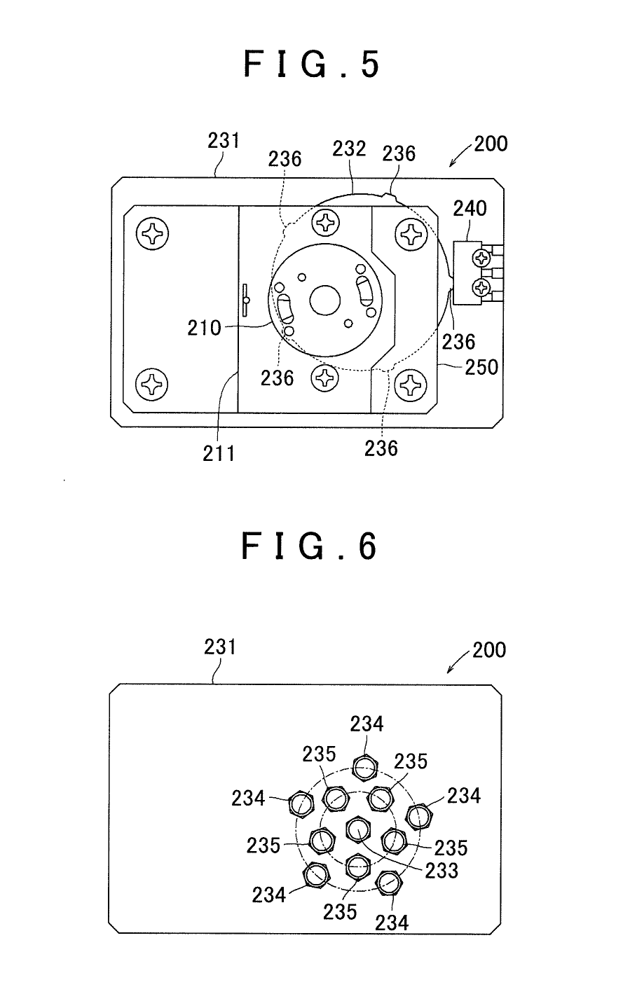

FIGS. 1 to 12 show one embodiment of the invention. The embodiment shows an example in which a massage apparatus according to the invention is applied to an vehicle seat (hereinafter referred to simply as a seat). The massage apparatus includes a plurality of bladders 311 to 316, 321 to 324 that are disposed along a seating surface of a seatback 2 constituting a backrest and a seating surface of a seat cushion 1 constituting a seat portion in the seat, respectively. A headrest 3 that supports a head portion of an occupant from behind is also provided on an upper portion of the seatback 2.

Here, the bladders 321 to 324 on the seat cushion 1-side are bilaterally paired into two pairs, and the two pairs are respectively arranged on a front side and a rear side of the seat. The bladders 311 to 316 on the seatback 2-side are bilaterally paired into three pairs, and the three pairs are vertically arranged. The bladders 311 to 316 are fixed onto a bladder base 301 that is fixed within the seatback 2, and the bladders 321 to 324 are fixed onto a bladder base 301 that is fixed within the seat cushion 1. Each of hoses 330 is connected to each of the bladders 311 to 316, 321 to 324, and air is supplied thereto from a pump 400 via a rotary valve 230 described below. The bladders 311 to 316, 321 to 324 are configured to sequentially inflate with air supplied therein, and press the surfaces of the seat cushion 1 and the seatback 2 from inside. When air in the bladders 311 to 316, 321 to 324 is sequentially discharged, the bladders 311 to 316, 321 to 324 deflate, and a force for pressing the surfaces of the seat cushion 1 and the seatback 2 is released. Thus, the seat cushion 1 and the seatback 2 are restored to a normal state.

Air is supplied to and discharged from each of the bilateral pairs of the bladders 311 to 316, 321 to 324 as one set. For example, air is sequentially supplied to and discharged from the bladders 311 to 316, 321 to 324 from the rear side to the front side in the seat cushion 1 and from a lower side to an upper side in the seatback 2, so that a body of an occupant is massaged. Of course, air may be supplied to and discharged from the bladders 311 to 316, 321 to 324 in a reversed order from that described above.

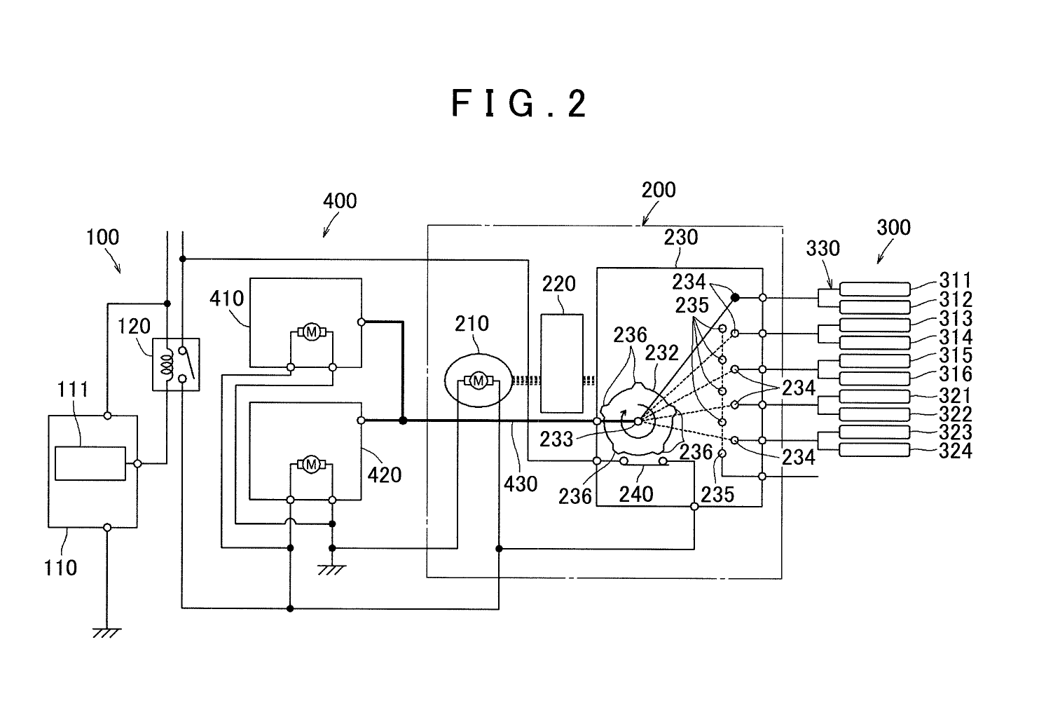

FIG. 2 shows electrical wiring and air piping used for performing the air supply and the air discharge with respect to the respective bladders 311 to 316, 321 to 324. The respective bladders 311 to 316, 321 to 324 are configured to be supplied with compressed air generated by the pump 400 via the rotary valve 230. The rotary valve 230 is configured to sequentially distribute air to the bladders 311 to 316, 321 to 324 as described above with a rotor 232 described below being rotated by a motor 210 via a gear in a gearbox 220.

The pump 400 includes two pumps 410, 420 that are arranged in parallel with each other. Motors of the two pumps 410, 420 are also electrically connected in parallel with each other, and are connected to a power source (not shown) via a relay 120. The above motor 210 is also connected in parallel with the two pumps 410, 420. The relay 120 is connected to a refresh switch 110 so as to be put into an ON state according to an operation of the refresh switch 110. The refresh switch 110 includes a timer 111. When a switch (not shown) provided in the refresh switch 110 is operated by one-touch, a contact of the relay 120 is put into an ON state by a period of time previously set by using a function of the timer 111.

Therefore, when the switch of the refresh switch 110 is operated by one-touch, the two pumps 410, 420, and the motor 210 are actuated by the set period of time, and air is sequentially supplied to and discharged from the bladders 311 to 316, 321 to 324. Projections 236 that constitute a cam are provided on an outer peripheral surface of the rotor 232 of the rotary valve 230. The number of the projections 236 is five that is equal to the number of sets of the bladders 311 to 316, 321 to 324. A limit switch 240 that is operated by the respective projections 236 to be turned OFF is provided. Each of the projections 236 is configured to turn OFF the limit switch 240 when the rotor 232 is at an air discharge position. The limit switch 240 is connected in parallel with the contact of the relay 120. When the contact of the relay 120 is changed from the ON state to an OFF state, the limit switch 240 remains to be turned ON until the rotor 232 reaches the air discharge position. Thus, the two pumps 410, 420, and the motor 210 are continuously actuated. When the rotor 232 reaches the air discharge position, and the limit switch 240 is turned OFF, the actuation of the two pumps 410, 420, and the motor 210 is stopped. When the respective bladders 311 to 316, 321 to 324 are stopped after performing a massage action by the set period of time as described above, the respective bladders 311 to 316, 321 to 324 are in a discharged state. The seat is thereby prevented from being in a deformed state by bladders 300 after the massage action is finished. Although the bladders 300 are actuated only by the period of time set by the timer 111, the bladders 300 may be continuously actuated while the switch is being operated.

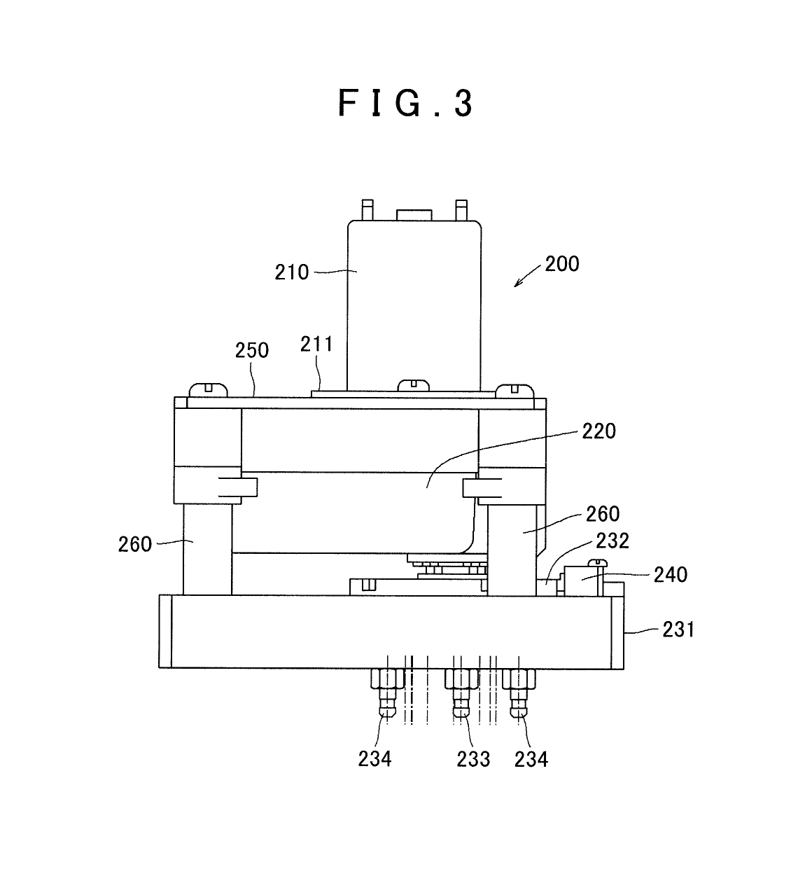

FIGS. 3 to 6 show an appearance of a rotary-type distributor 200. The rotary-type distributor 200 employs a stator 231 of the rotary valve 230 as a base member, and the gearbox 220 and the motor 210 are attached to the stator 231. To be more specific, a motor base 250 is supported by three posts 260 on the stator 231, and the motor 210 is attached onto the motor base 250 via a motor attachment plate 211. The gearbox 220 is also supported below the motor base 250. As described below, the rotor 232 of the rotary valve 230 disposed below the gearbox 220 is configured to be rotated by an output shaft of the gearbox 220. Moreover, the limit switch 240 that is operated by the projections 236 of the cam on an outer periphery of the rotor 232 of the rotary valve 230 is supported on the stator 231.

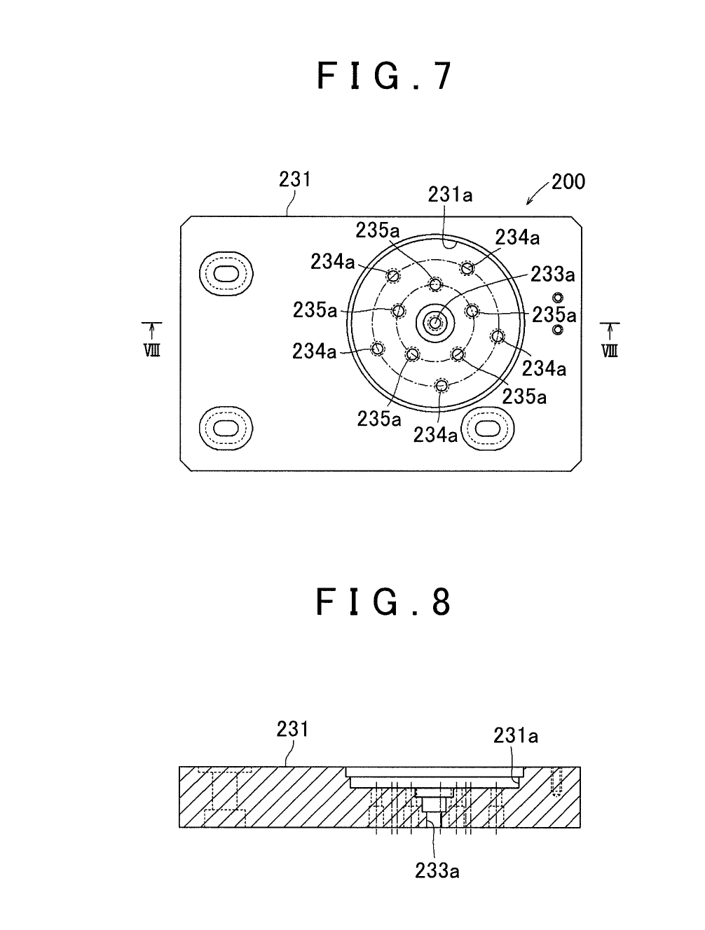

FIGS. 7, 8 show the stator 231 alone. A recessed portion 231a that receives the rotor 232 is formed in a surface of the stator 231. Five output holes 234a that are air passages connected to the bladders 311 to 316, 321 to 324, respectively, one air supply hole 233a that is an air passage connected to the pumps 410, 420, and five air discharge holes 235a that are air passages open to the atmosphere are formed in a bottom of the recessed portion 231a. The output holes 234a are dispersedly arranged in a circular shape, and the air supply hole 233a is disposed in the center of the circular shape. The air discharge holes 235a are disposed between the output holes 234a and the air supply hole 233a in a radial direction of the circular shape, and are dispersedly arranged concentrically with the output holes 234a.

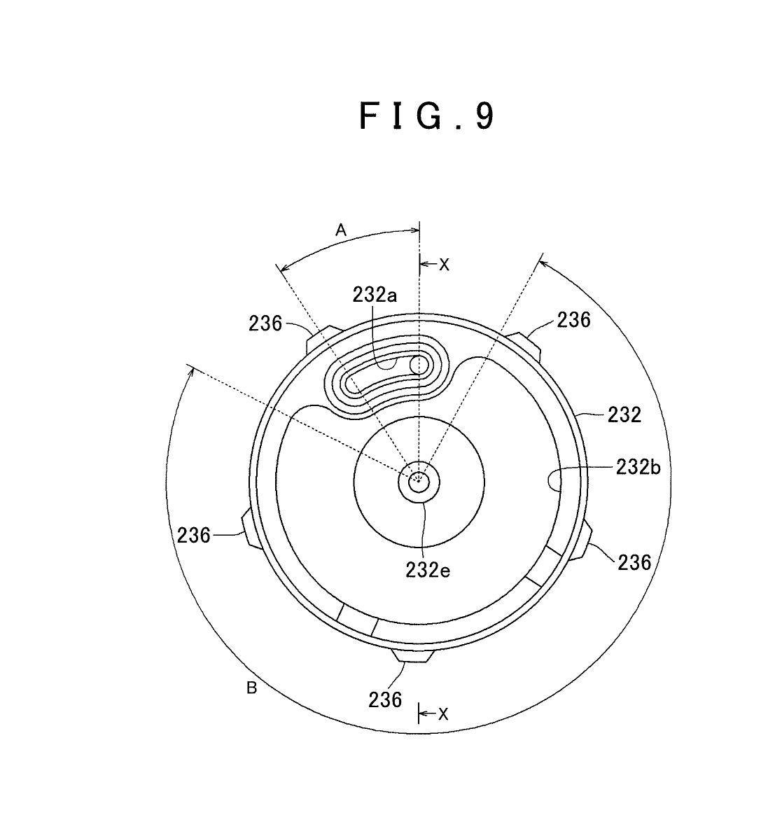

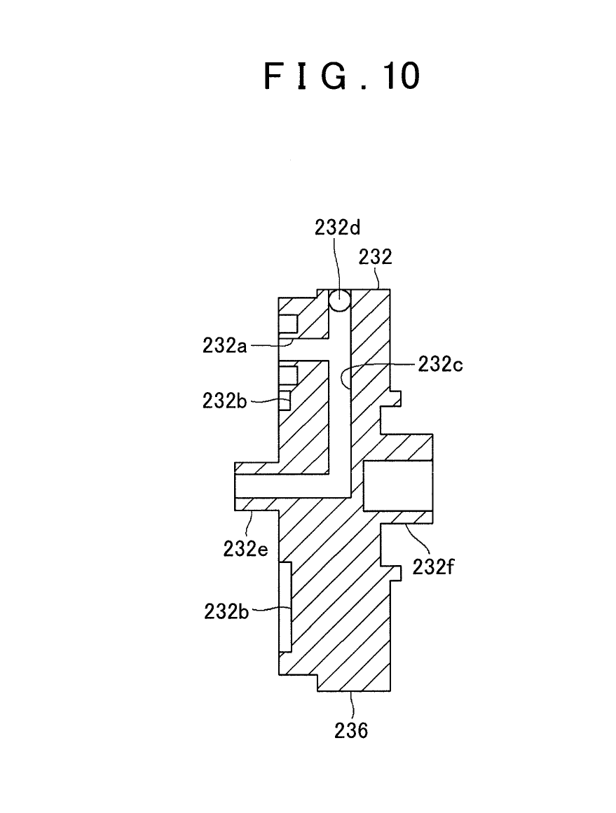

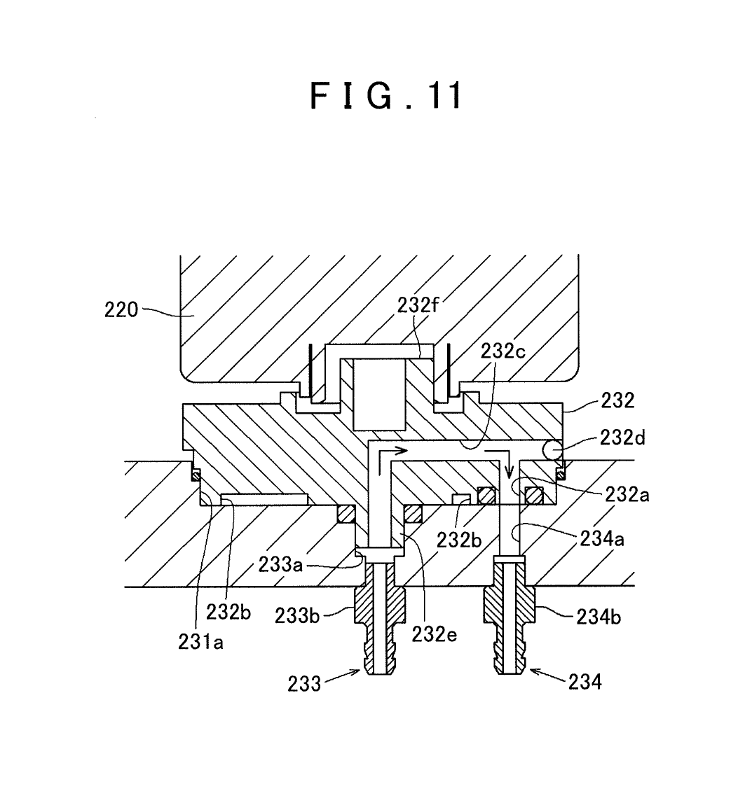

FIGS. 9, 10 show the rotor 232 alone. The rotor 232 is rotated within the recessed portion 231a of the stator 231 with a bottom surface being fitted to the recessed portion 231a. A connection portion 232f is formed projecting on an upper surface of the rotor 232, and is connected to the output shaft of the gearbox 220 such that the rotor 232 is rotated upon receiving a rotational output of the output shaft. A tower portion 232e is provided corresponding to the air supply hole 233a of the stator 231 on the bottom surface of the rotor 232. An output groove 232a is provided corresponding to a portion of the circular shape in which the output holes 234a of the stator 231 are disposed, and an air discharge groove 232b is provided corresponding to both of a remaining portion of the circular shape in which the output holes 234a of the stator 231 are disposed and an entire circular shape in which the air discharge holes 235a are disposed. Therefore, the air discharge groove 232b is formed so as to circumferentially sandwich the output groove 232a. The output groove 232a is set to an angular range A that does not include more than one output hole 234a of the stator 231 at the same time. The air discharge groove 232b is set to an angular range B that includes four of the output holes 234a of the stator 231, but not five, at the same time. All of the five air discharge holes 235a correspond to the air discharge groove 232b at all times regardless of a rotational angle of the rotor 232.

An air supply passage 232c is formed through the tower portion 232e. The air supply passage 232c is in communication with the output groove 232a in the rotor 232. The air supply passage 232c is formed opening in a side portion of the rotor 232 for convenience of manufacture. A steel ball 232d is press-fitted into an end portion of the air supply passage 232c in order to close the opening.

An outer circumference of the rotor 232 has a cam shape. Each of the projections 236 of the cam is formed projecting at an angular position where each of the output holes 234a of the stator 231 most recently corresponding to the output groove 232a of the rotor 232 assumes a position corresponding to the air discharge groove 232b of the rotor 232 with the rotor 232 moving to the air discharge position. As described above, each of the projections 236 comes into abutment with the limit switch 240 to turn OFF the limit switch 240. Each of the projections 236 is formed in a shape in which a front end portion and a rear end portion in a rotational direction of the rotor 232 have inclined surfaces, respectively, such that a projection amount with respect to the limit switch 240 gradually changes along with the rotation of the rotor 232 at a start and an end of the abutment with the limit switch 240. Therefore, an abutting force at the start and the end of the abutment between each of the projections 236 and the limit switch 240 does not rapidly change, but gradually changes. Accordingly, wear of an abutting portion between each of the projections 236 and the limit switch 240 is suppressed, and durability can be improved. Since the cam is configured only by forming the projections 236 on the outer circumference of the rotor 232, and it is not necessary to configure a new cam, a configuration can be simplified.

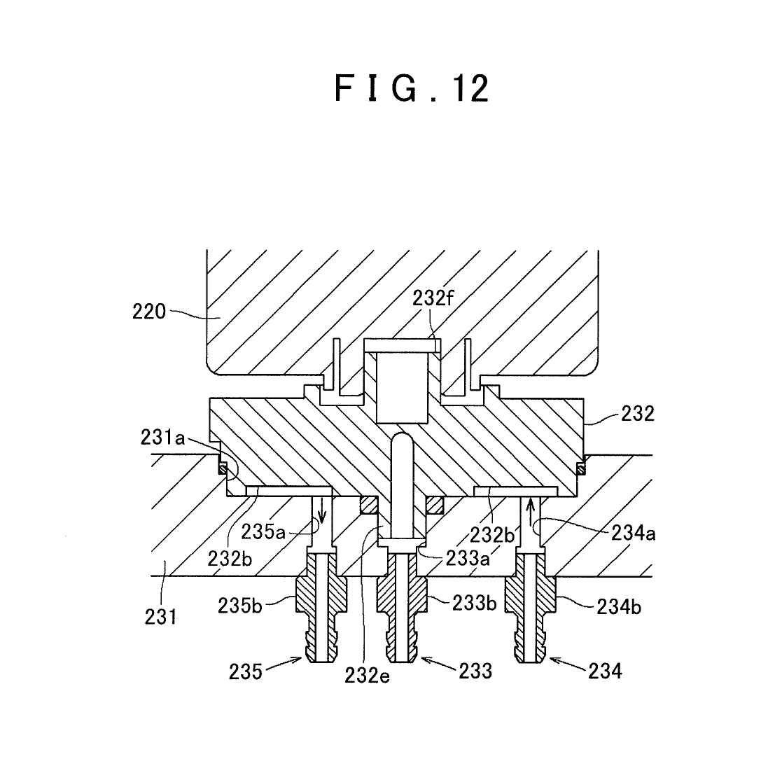

FIGS. 11, 12 show a state in which the stator 231 and the rotor 232 of the rotary valve 230 are combined together in an enlarged manner. In FIG. 11, a manner in which the output groove 232a of the rotor 232 is at a position corresponding to one of the output holes 234a of the stator 231, and air supplied to the air supply hole 233a is supplied to the output hole 234a through the air supply passage 232c is indicated by arrows. Joints 233b, 234b are screwed into the air supply hole 233a and the output holes 234a to constitute an air supply port 233 and output ports 234, respectively. A hose 430 from the pumps 410, 420 is connected to a free end of the joint 233b of the air supply port 233. The hoses 330 to the bladders 311 to 316, 321 to 324, respectively, are connected to free ends of the joints 234b of the output ports 234. Note that the tower portion 232e of the rotor 232 is inserted into the air supply hole 233a, and forms the center of rotation of the rotor 232 in the recessed portion 231a of the stator 231. A seal member that prevents air leakage between the stator 231 and the rotor 232 is provided at an appropriate position in a sliding portion between the stator 231 and the rotor 232.

In FIG. 12, a manner in which the output hole 234a most recently corresponding to the output groove 232a of the rotor 232 out of the output holes 234a of the stator 231 assumes a position corresponding to the air discharge groove 232b of the rotor 232, the output hole 234a comes into communication with the air discharge holes 235a via the air discharge groove 232b, and the air discharge is performed is indicated by arrows. Joints 235b are screwed into the air discharge holes 235a to constitute air discharge ports 235. Hoses may be connected to free ends of the joints 235b of the air discharge ports 235, and guided to an appropriate position in a vehicle to discharge air. Alternatively, air may be directly discharged from the joints 235b without connecting the hoses to the joints 235b. At this time, all of the five air discharge holes 235a of the stator 231 are at positions corresponding to the air discharge groove 232b of the rotor 232, so that air discharged from the bladders 300 through the output ports 234 is efficiently and quickly discharged. Moreover, since an amount of discharged air per one air discharge port 235 is reduced, a discharge sound generated when air flows through the air discharge ports 235 at high speed can be suppressed. Also, since the air discharge groove 232b of the rotor 232 is set to the angular range B that occupies about two thirds of the entire rotational angle of the rotor 232, each of the output holes 234a continuously assumes the position corresponding to the air discharge groove 232b over a relatively long time after reaching the position corresponding to the air discharge groove 232b. Thus, the air discharge of the bladders 300 can be performed slowly over time, and a discharge sound generated when air flows through the output ports 234 at high speed can be also suppressed.

In accordance with the above embodiment, since the pump 400 and the rotary-type distributor 200 are stopped by the rotor 232 (the cam) and the limit switch 240 in the rotary-type distributor 200, an extra circuit such as a conventional circuit that actuates a counter becomes unnecessary, and a circuit configuration can be simplified.

Although the particular embodiment has been described above, the invention is not limited to the appearance and the configuration, and various changes, additions, and deletions may be made therein without departing from the scope of the invention. For example, although the invention is applied to the vehicle (automobile) seat in the above embodiment, the invention may be applied to a seat mounted in aircrafts, ships, and trains. The invention may be also applied to a fixed-type exclusive massage apparatus.

What is claimed is:

1. A massage apparatus that performs a massage action by sequentially supplying and discharging air to and from a plurality of bladders via a distributor, the massage apparatus comprising:
a pump that is an air supply source;
a motor that actuates the distributor;
a power switch that optionally supplies power to the pump and the motor to actuate the pump and the motor; and
a limit switch that is connected in parallel with the power switch, and is operated by a cam working with the distributor so as to be turned ON when the distributor assumes a position to supply air to any of the bladders, and so as to be turned OFF when the distributor assumes a position to discharge air from at least any of the bladders.

2. The massage apparatus according to claim 1,
wherein the distributor is a rotary-type distributor, and the rotary-type distributor includes: a stator having a plurality of output ports that are air passages connected to the bladders, respectively, an air supply port that is an air passage connected to the pump, and an air discharge port that is an air passage open to an atmosphere; a rotor that rotates relative to the stator, and, at each of a plurality of air supply positions set for each predetermined rotational angle, brings the air supply port into communication with an output port of a bladder corresponding to the air supply position out of the output ports, and, at a plurality of air discharge positions set between the respective air supply positions, brings the air discharge port into communication with the output port most recently in communication with the air supply port; and the cam that is set on a rotational outer periphery of the rotor, and is formed so as to turn OFF the limit switch at a position corresponding to each of the air discharge positions, and turn ON the limit switch at a position other than the air discharge positions.

3. The massage apparatus according to claim 2,
wherein in the stator, the plurality of output ports are dispersedly arranged in a circular shape, the air supply port is disposed in a center of the circular shape, the air discharge port is disposed between the output ports and the air supply port in a radial direction of the circular shape, the plurality of air discharge ports are dispersedly arranged concentrically with the plurality of output ports, and the rotor brings the output port most recently in communication with the air supply port into communication with all of the air discharge ports at each of the air discharge positions.

4. The massage apparatus according to claim 2,
wherein the cam includes a projection that is provided projecting to an outer peripheral side of the rotor corresponding to each of the air discharge positions set between the respective air supply positions in the rotor, the limit switch is turned OFF when the projection of the cam comes into abutment with the limit switch, and is turned ON when the projection of the cam is separated from the limit switch, and the projection is formed so as to have an inclined surface at a front end portion in a rotational direction of the rotor such that a projection amount with respect to the limit switch is gradually increased along with the rotation of the rotor when the projection starts to abut with the limit switch.
